(19) United States
(12) Patent Application Publication
(10) Pub. No.: US 2026/0349636 A1
(43) Pub. Date: Nov. 5, 2026

(54) CONTROLLING A COMPUTING DEVICE DISPLAY WITH DISPLAY CUT OUT

(71) Applicant: QUALCOMM Incorporated, San Diego, CA (US)

(72) Inventors: Nan ZHANG, Beijing (CN); Xinchao YANG, Shanghai (CN); Yongjun XU, Beijing (CN)

(21) Appl. No.: 19/109,823

(22) PCT Filed: Oct. 18, 2022
(86) PCT No.: PCT/CN2022/125808

§ 371 Date: Mar. 7, 2025

(51) Int. Cl. G06F 3/14

(52) U.S. Cl. CPC G06F 3/14

(57) ABSTRACT

Embodiments may include a computing device configured to control a display that includes a display cut out. In some aspects, the computing device may monitor whether an ambient light intensity meets an ambient light threshold, and may control the display to present a display mask region that substantially matches the display cut out in response to the ambient light intensity meeting the ambient light threshold.

### BACKGROUND

Computing devices such as smartphones, tablets, and others often include a touchscreen device capable of display functions and receiving user input. Such computing devices also are often equipped with cameras, ambient light sensors, and other devices that are oriented in the same direction as the display. Because such devices are designed to be hand-held, the display screen is relatively small. To conserve scarce display area, often the cameras, light sensors, and other device are disposed under the display, and the display includes a region that is physically cut away to enable the camera, sensors, etc. to function. To visually disguise the display cut out, the device display can be controlled to display a graphical mask region around the display cut out that is similar in color to the physical cut out. However, a difference in appearance between the display cut out and the mask region is often visually apparent, particularly in brightly lit areas or in sunlight. This difference is unappealing, and may distract from the display function of the device, potentially interfering in the function of the computing device.

### SUMMARY

Various aspects include methods and computing device configured to perform the methods for controlling a computing device display that includes a display cut out. Various aspects may include monitoring whether an ambient light intensity meets an ambient light threshold, and controlling the display to present a display mask region that substantially matches the display cut out in response to the ambient light intensity meeting the ambient light threshold.

In some aspects, controlling the display to present a display mask region that substantially matches the display cut out may include controlling the display to present the display mask region based on one or more user interface elements being presented on the display.

In some aspects, controlling the display to present a display mask region that substantially matches the display cut out may include generating a display mask layer that corresponds to the display cut out based on one or more user interface elements being presented by the display, determining the display mask region based on the display cut out and the one or more user interface elements being presented by the display, modifying the display mask layer by the determined display mask region, and controlling the display to present the modified display mask layer.

In some aspects, determining the display mask region based on the display cut out and the one or more user interface elements being presented by the display may include receiving information about the user interface elements from an application generating the user interface elements, and dynamically generating the display mask region to substantially match the display cut out based on the information about the user interface elements received from the application.

In some aspects, controlling the display to present a display mask region that substantially matches the display cut out in response to ambient light intensity meeting a ambient light threshold may include controlling the display to present a first display mask region at a first time based on a first ambient light intensity and controlling the display to present a second display mask region at a second time based on a second ambient light intensity.

Further aspects may include a computing device having a processor configured to perform one or more operations of any of the methods summarized above. Further aspects may include a non-transitory processor-readable storage medium having stored thereon processor-executable instructions configured to cause a processor of a computing device to perform operations of any of the methods summarized above.

Further aspects include a computing device having means for performing functions of any of the methods summarized above. Further aspects include a system on chip for use in a computing device that includes a processor configured to perform one or more operations of any of the methods summarized above.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIG. 1A illustrates an example computing device suitable for implementing any of the various embodiments.

FIGS. 1B-1E illustrate example computing devices displaying mask regions that are substantially larger than display cut outs.

FIG. 2 is a component block diagram illustrating an example computing system suitable for implementing any of the various embodiments.

FIG. 3 is a functional block diagram of an example computing device suitable for implementing various embodiments.

FIGS. 4A-4C illustrate methods of controlling a computing device display that includes a display cut out according to various embodiments.

FIG. 5A is a process flow diagram illustrating a method that may be performed by a processor of a computing device for controlling a computing device display that includes a display cut out according to various embodiments.

FIGS. 5B-5D are process flow diagrams illustrating operations that may be performed by a processor of a computing device as part of the method for controlling a computing device display that includes a display cut out according to various embodiments.

FIG. 6 that is a component block diagram of a computing device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and embodiments are for illustrative purposes, and are not intended to limit the scope of the claims.

Various embodiments include systems and methods for controlling a computing device display that includes a display cut out. Various embodiments may improve the operation of a computing device by improving the operation of the display of the computing device, in particular computing devices having a display with a physical cut out.

The term “computing device” is used herein to refer to any one or all of cellular telephones, smartphones, portable computing devices, personal or mobile multi-media players, laptop computers, tablet computers, smartbooks, ultrabooks, palmtop computers, wireless electronic mail receivers, multimedia Internet-enabled cellular telephones, medical devices and equipment, biometric sensors/devices, wearable devices including smart watches, smart clothing, smart glasses, smart wrist bands, smart jewelry (e.g., smart rings, smart bracelets, etc.), entertainment devices (e.g., gaming controllers, music and video players, satellite radios, etc.), wireless-network enabled Internet of Things (IoT) devices including smart meters/sensors, router devices, industrial manufacturing equipment, large and small machinery and appliances for home or enterprise use, computing devices affixed to or incorporated into various mobile platforms, global positioning system devices, and similar electronic devices that include a memory, wireless communication components and a programmable processor.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. An SIP may also include multiple independent SOCs coupled together via high speed communication circuitry and packaged in close proximity, such as on a single motherboard or in a single wireless device. The proximity of the SOCs facilitates high speed communications and the sharing of memory and resources.

As used herein, the terms “network,” “system,” “wireless network,” “cellular network,” and “wireless communication network” may interchangeably refer to a portion or all of a wireless network of a carrier associated with a wireless device and/or subscription on a wireless device. The techniques described herein may be used for various wireless communication networks, such as Code Division Multiple Access (CDMA), time division multiple access (TDMA), FDMA, orthogonal FDMA (OFDMA), single carrier FDMA (SC-FDMA) and other networks. In general, any number of wireless networks may be deployed in a given geographic area. Each wireless network may support at least one radio access technology, which may operate on one or more frequency or range of frequencies. For example, a CDMA network may implement Universal Terrestrial Radio Access (UTRA) (including Wideband Code Division Multiple Access (WCDMA) standards), CDMA2000 (including IS-2000, IS-95 and/or IS-856 standards), etc. In another example, a TDMA network may implement GSM Enhanced Data rates for GSM Evolution (EDGE). In another example, an OFDMA network may implement Evolved UTRA (E-UTRA) (including LTE standards), Institute of Electrical and Electronics Engineers (IEEE) 802.11 (Wi-Fi), IEEE 802.16 (WiMAX), IEEE 802.20, Flash-OFDM®, etc. Reference may be made to wireless networks that use LTE standards, and therefore the terms “Evolved Universal Terrestrial Radio Access,” “E-UTRAN” and “eNodeB” may also be used interchangeably herein to refer to a wireless network. However, such references are provided merely as examples, and are not intended to exclude wireless networks that use other communication standards. For example, while various Third Generation (3G) systems, Fourth Generation (4G) systems, and Fifth Generation (5G) systems are discussed herein, those systems are referenced merely as examples and future generation systems (e.g., sixth generation (6G) or higher systems) may be substituted in the various examples.

Computing devices also are often equipped with cameras, ambient light sensors, and other devices that are disposed under the display of the computing device. A region of the display is physically cut out to enable the camera, sensors, etc. to function (referred to herein as a “display cut out”). To visually disguise the display cut out, the device display can be controlled to display a graphical mask region (referred to herein as a “display mask region”) around the display cut out that is similar in color to the physical cut out. The display mask region is sometimes referred to variously as a “flexible mask user interface (UI) layer,” a “dynamic island,” a “dynamic visual cutout region,” and other similar names. However, a difference in appearance between the display cut out and the mask region is often visually apparent, particularly in brightly lit areas or in sunlight. For example, a pixel value of the display mask region may be set to zero, indicating, for example, “no color,” “do not emit,” “black,” etc. However, if the ambient light intensity is sufficiently strong, the display cut out and the display mask region reflect different colors, and are easily distinguishable. This difference may distract from the display function of the device, and may interfere with functions of the computing device.

Various embodiments include methods and computing devices configured to perform the methods for controlling a computing device display that includes a display cut out. Some embodiments may include monitoring whether an ambient light intensity (i.e., the brightness or intensity of ambient light) meets an ambient light threshold, and controlling the display to present a display mask region that substantially matches the display cut out in response to the ambient light intensity meeting the ambient light threshold. In some embodiments, the computing device may dynamically determine the ambient light threshold based on one or more user interface elements being presented by the display. In some embodiments, the computing device may apply a static ambient light threshold.

In some embodiments, the computing device may generate a display mask region that substantially matches a shape of the display cut out. In some embodiments, the computing device may generate a display mask region that substantially matches a height of the display cut out. In some embodiments, the computing device may generate a display mask region that substantially matches a width of the display cut out. In some embodiments, the computing device may generate the display mask region based on one or more user interface elements being presented by the display outside of the display mask region. In some embodiments, the computing device may generate the display mask region based on one or more user interface elements being presented within the display mask region.

For example, in some embodiments, the computing device may generate a display mask layer that corresponds to the display cut out based on one or more user interface elements being presented by the display. Such user interface elements may be presented outside of the display mask layer and/or within the display mask layer. The computing device may determine the display mask region based on the display cut out and the one or more user interface elements being presented by the display device. The computing device may modify the display mask layer by the determined display mask region, and may control the display to present the modified display mask layer.

In some embodiments, the computing device may dynamically generate the display mask region based on information received from an application that generates one or more user interface elements. In some embodiments, the computing device may receive information about the user interface elements from an application generating the user interface elements, and may dynamically generate the display mask region to substantially match the display cut out based on the information about the user interface elements received from the application. The computing device may modify the display mask layer by the dynamically determined display mask region, and may control the display to present the modified display mask layer.

In some embodiments, the computing device may dynamically modify the display mask region in response to changing ambient light intensity. In some embodiments, the computing device may apply two or more ambient light thresholds, and may dynamically modify the display mask region in response to the ambient light intensity meeting a first threshold, a second threshold, etc. In some embodiments, the computing device may present a first display mask region at a first time based on a first ambient light intensity and a second display mask region at a second time based on a second ambient light intensity.

Various embodiments improve the operation of a computing device by enabling the computing device to dynamically generate and/or modify a display mask region to substantially match a display cut out based on the intensity of ambient light. Enabling computing devices to dynamically determine a present a display mask region the substantially matches the display cut out reduces distraction caused by a visual difference between the display mask region and the display cut out. Enabling computing devices to dynamically determine and present a display mask region the substantially matches the display cut out may reduce interference with functions of the computing device caused by a visual difference between the display mask region and the display cut out.

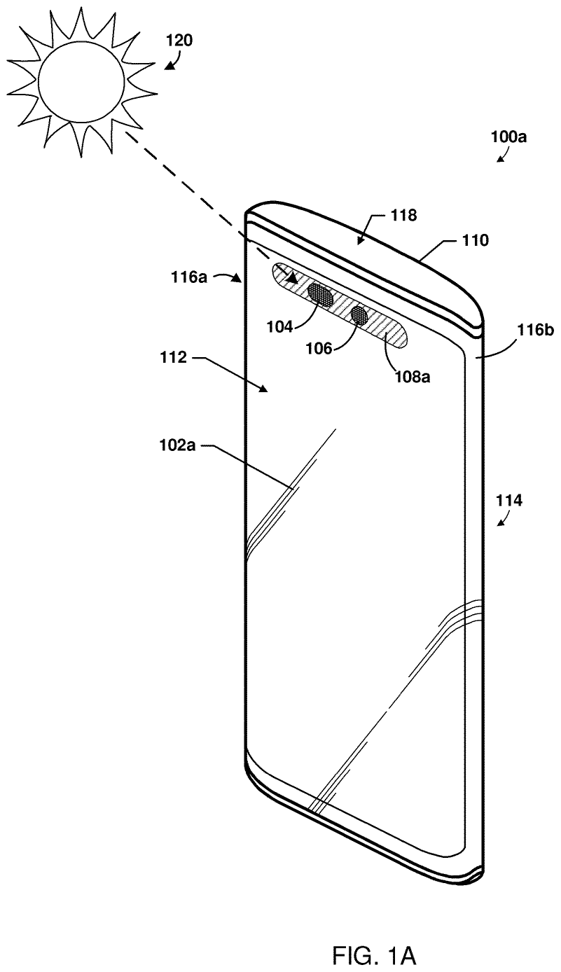

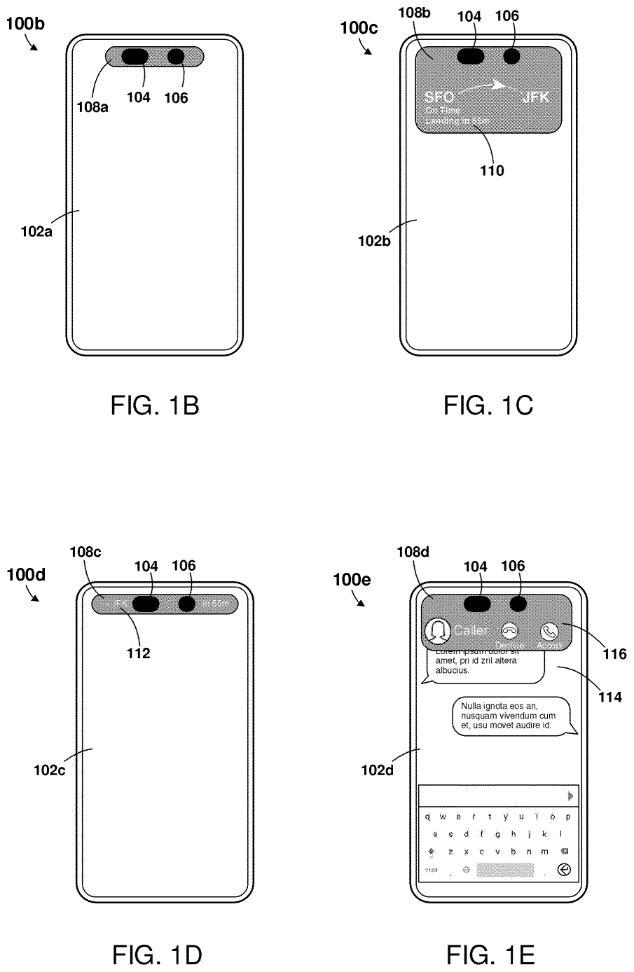

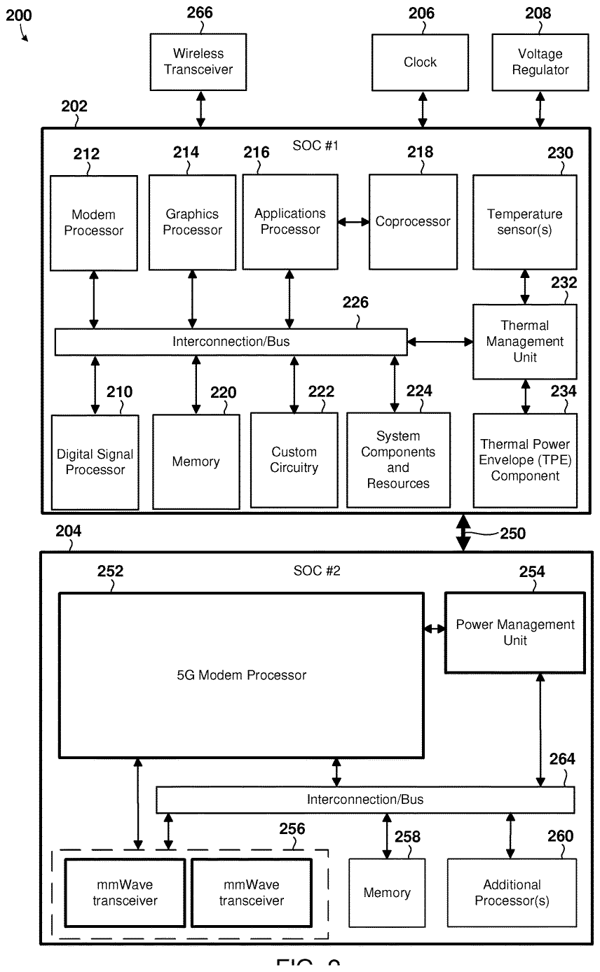

FIG. 1A illustrates an example computing device 100a suitable for implementing any of the various embodiments. The computing device 100 may include a body 110 having a front area 112, a rear area 114, two sides 116a, 116b between the front area 112 and the rear area 114, and a top area 118 between the front area 112 and the rear area 114. The front area 112 may include a display 102a that incorporates a touch sensor device to form a touchscreen display. The touch sensor is configured to detect a change in capacitance at a location where the sensor is touched (or nearly touched) by an object, particularly be a user's hand, thumb or fingers.

The display 102a may incorporate one or more display cut outs 104, 106. The display cut outs 104, 106 may be formed to accommodate the operation of one or more devices disposed behind the display 102a, such as a camera, an ambient light sensor, and/or other suitable devices. A processor of the computing device 100 may control the display 102a to display a mask region 108a. Conventionally, the display mask region is substantially larger than the display cut outs 104, 106. The processor of the computing device may configure the display mask region with a color, or no color, similar to a color visible in the display cut outs 104, 106. However, in the presence of sufficiently intense ambient light, such as sunlight 120, a difference between the display mask region 108a and the display cut outs 104, 106 is readily apparent.

FIGS. 1B-1E illustrate example computing devices 100b-100e displaying mask regions that are substantially larger than display cut outs. For example, the computing device 100b includes a display 102a having display cut outs 104, 106. The computing device is controlling the display 102a to display a mask region 108a that is substantially larger than the area of the display cut outs 104, 106. As another example, the computing device 100c is controlling a display 102b to display mask region 108b that is substantially larger than the area of the display cut outs 104, 106, and which includes graphical elements 110. In this example, the graphical elements 110 include information about an airplane flight.

As another example, the computing device 100d is controlling a display 102c to display mask region 108c that is substantially larger than the area of the display cut outs 104, 106, and which includes graphical elements 112. The display mask region 108c is smaller than the display mask region 108b, but the display mask region 108c is still substantially larger than the area of the display cut outs 104, 106.

As another example, the computing device 100e is controlling a display 102d to display graphical elements 114 of an application (in this example, graphical elements of a text messaging application, including a keyboard and text bubbles) and a display mask region 108d superimposed over at least some of the graphical elements 114. In this example, the display mask region 108d includes graphical elements 116. As one example, the graphical elements 116 indicate an incoming phone call and a caller ID, and also include virtual buttons enabling a user to accept or decline the incoming call.

Each of the display mask regions 108a-108d are substantially larger than the display cut outs 104, 106. In sufficiently intense ambient light conditions, a visual difference between the display mask regions 108a-108d and the display cut outs 104, 106 is pronounced. The pronounced visual difference between the display mask regions 108a-108d and the display cut outs 104, 106 may interfere with the function of an application executing on the computing device 102a-102e, and may be distracting to the user. Further, the difference between the display mask regions 108a-108d and the display cut outs 104, 106 may be visually unappealing.

FIG. 2 is a component block diagram illustrating an example computing system 200 suitable for implementing any of the various embodiments. Various embodiments may be implemented on a number of single processor and multiprocessor computer systems, including a system-on-chip (SOC) or system in a package (SIP).

With reference to FIGS. 1A-2, the illustrated example computing system 200 (which may be a SIP in some embodiments) includes a two SOCs 202, 204 coupled to a clock 206, a voltage regulator 208, and a wireless transceiver 266 configured to send and receive wireless communications via an antenna (not shown) to/from a wireless device (e.g., 120a-120e) or a base station (e.g., 110a-110d). In some embodiments, the first SOC 202 may operate as central processing unit (CPU) of the wireless device that carries out the instructions of software application programs by performing the arithmetic, logical, control and input/output (I/O) operations specified by the instructions. In some embodiments, the second SOC 204 may operate as a specialized processing unit. For example, the second SOC 204 may operate as a specialized 5G processing unit responsible for managing high volume, high speed (e.g., 5 Gbps, etc.), and/or very high frequency short wavelength (e.g., 28 GHz mm Wave spectrum, etc.) communications.

The first SOC 202 may include a digital signal processor (DSP) 210, a modem processor 212, a graphics processor 214, an application processor 216, one or more coprocessors 218 (e.g., vector co-processor) connected to one or more of the processors, memory 220, custom circuity 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, the plurality of mm Wave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (e.g., FreeBSD, LINUX, OS X, etc.) and a processor that executes a second type of operating system (e.g., MICROSOFT WINDOWS 10). In addition, any or all of the processors 210, 212, 214, 216, 218, 252, 260 may be included as part of a processor cluster architecture (e.g., a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 224 and/or custom circuitry 222 may also include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates and/or implement a bus architecture (e.g., CoreConnect, AMBA, etc.). Communications may be provided by advanced interconnects, such as high-performance networks-on chip (NoCs).

The first and/or second SOCs 202, 204 may further include an input/output module (not illustrated) for communicating with resources external to the SOC, such as a clock 206 and a voltage regulator 208. Resources external to the SOC (e.g., clock 206, voltage regulator 208) may be shared by two or more of the internal SOC processors/cores.

In addition to the example SIP 200 discussed above, various embodiments may be implemented in a wide variety of computing systems, which may include a single processor, multiple processors, multicore processors, or any combination thereof.

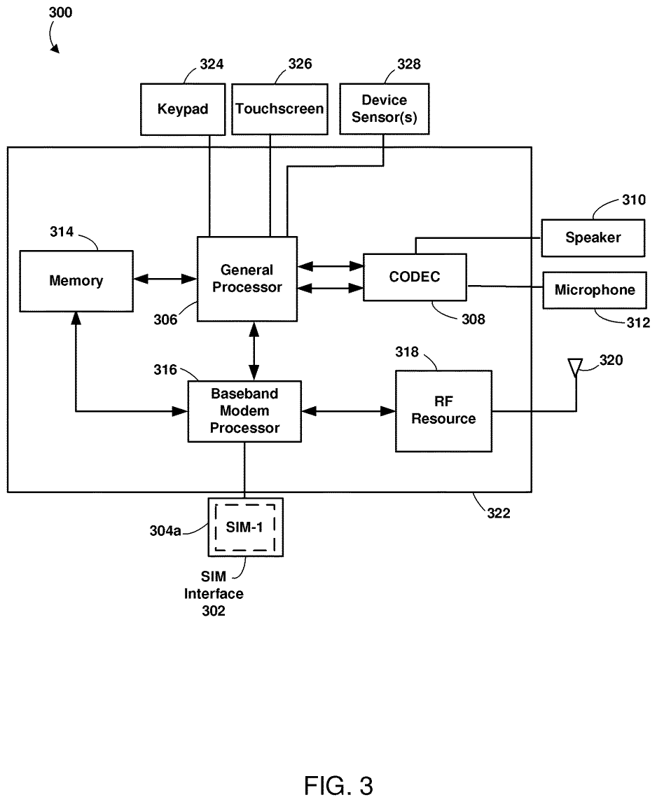

FIG. 3 is a functional block diagram of an example computing device 300 suitable for implementing various embodiments. With reference to FIGS. 1A-3, the computing device 300 may be similar to the computing device 100. For example, the computing device 300 may be a multi-SIM computing device, such as a multiple SIM multiple standby (MSMS) computing device. The computing device 300 may include at least one subscriber identity module (SIM) interface 302, which may receive a first SIM (“SIM-1”) 304a that is associated with a first subscription. In some embodiments, the at least one SIM interface 302 may be implemented as multiple SIM interfaces 302, which may receive at least a second that is associated with at least a second subscription.

A SIM in various embodiments may be a Universal Integrated Circuit Card (UICC) that is configured with SIM and/or universal SIM (USIM) applications, enabling access to a variety of different networks. The UICC may also provide storage for a phone book and other applications. Alternatively, in a code division multiple access (CDMA) network, a SIM may be a UICC removable user identity module (R-UIM) or a CDMA subscriber identity module (CSIM) on a card.

Each SIM 304a may have a CPU, ROM, RAM, EEPROM and I/O circuits. One or more of the first SIM 304a and any additional SIMs used in various embodiments may contain user account information, an international mobile station identifier (IMSI), a set of SIM application toolkit (SAT) commands and storage space for phone book contacts. One or more of the first SIM 304a and any additional SIMs may further store home identifiers (e.g., a System Identification Number (SID)/Network Identification Number (NID) pair, a Home PLMN (HPLMN) code, etc.) to indicate the SIM network operator provider. An Integrated Circuit Card Identity (ICCID) SIM serial number may be printed on one or more SIM 304a for identification. In some embodiments, additional SIMs may be provided for use on the computing device 300 through a virtual SIM (VSIM) application (not shown). For example, the VSIM application may implement remote SIMs on the computing device 300 by provisioning corresponding SIM profiles.

The computing device 300 may include at least one controller, such as a general-purpose processor 306, which may be coupled to a coder/decoder (CODEC) 308. The CODEC 308 may in turn be coupled to a speaker 310 and a microphone 312. The general-purpose processor 306 may also be coupled to at least one memory 314. The memory 314 may be a non-transitory tangible computer readable storage medium that stores processor-executable instructions. For example, the instructions may include routing communication data relating to a subscription though the transmit chain and receive chain of a corresponding baseband-RF resource chain. The memory 314 may store operating system (OS), as well as user application software and executable instructions. The general-purpose processor 306 and memory 314 may each be coupled to at least one baseband-modem processor 316. Each SIM 304a in the computing device 300 may be associated with a baseband-RF resource chain that includes at least one baseband-modem processor 316 and at least one radio frequency (RF) resource 318.

The RF resource 318 may include receiver and transmitter circuitry coupled to at least one antenna 320 and configured to perform transmit/receive functions for the wireless services associated with each SIM 304a of the computing device 300. The RF resource 318 may implement separate transmit and receive functionalities, or may include a transceiver that combines transmitter and receiver functions. The RF resource 318 may be configured to support multiple radio access technologies/wireless networks that operate according to different wireless communication protocols. The RF resource 318 may include or provide connections to different sets of amplifiers, digital to analog converters, analog to digital converters, filters, voltage controlled oscillators, etc. Multiple antennas 320 and/or receive blocks may be coupled to the RF resource 318 to facilitate multimode communication with various combinations of antenna and receiver/transmitter frequencies and protocols (e.g., LTE, Wi-Fi, Bluetooth and/or the like).

The baseband-modem processor of a computing device 300 may be configured to execute software including at least one modem stack associated with at least one SIM. SIMs and associated modem stacks may be configured to support a variety of communication services that fulfill different user requirements. Further, a particular SIM may be provisioned with information to execute different signaling procedures for accessing a domain of the core network associated with these services and for handling data thereof.

In some embodiments, the general-purpose processor 306, memory 314, baseband-modem processor 316, and RF resource 318 may be included in a system-on-chip device 322. The SIMS 304a and their corresponding interface(s) 302 may be external to the system-on-chip device 322. Further, various input and output devices may be coupled to components of the system-on-chip device 322, such as interfaces or controllers. Example user input components suitable for use in the computing device 300 may include, but are not limited to, a keypad 324, a touchscreen 326 (e.g., 102a), such as a beveled edge touchscreen.

In some embodiments, the general-purpose processor 306 may be coupled to one or more device sensors 328. The device sensor(s) 328 may provide an output that includes information about the environment around the computing device 300. For example, the computing device may include an ambient light sensor configured to sense and intensity of ambient light incident on the ambient light sensor, and to provide an output to the general-purpose processor 306 including information about the intensity of the ambient light.

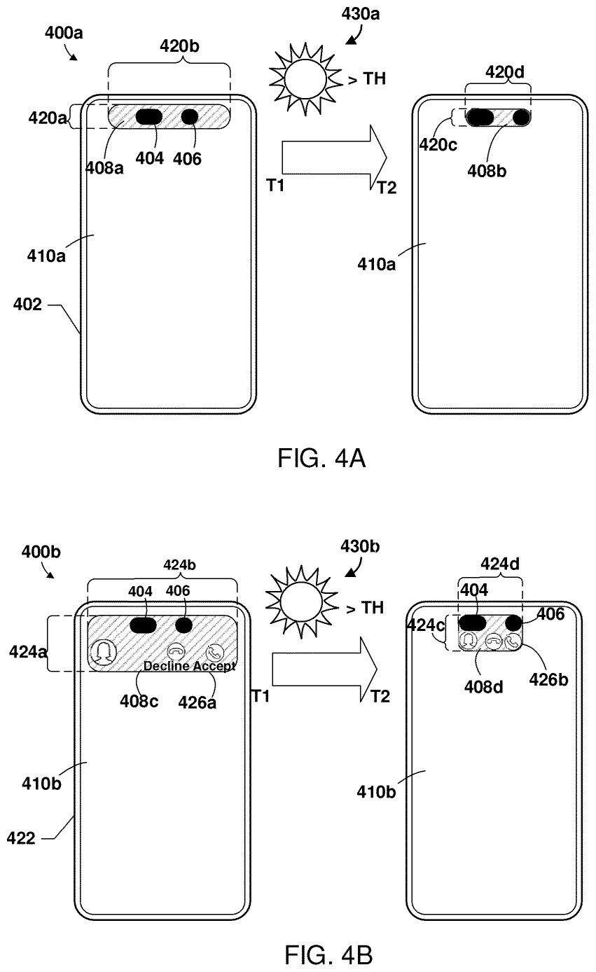

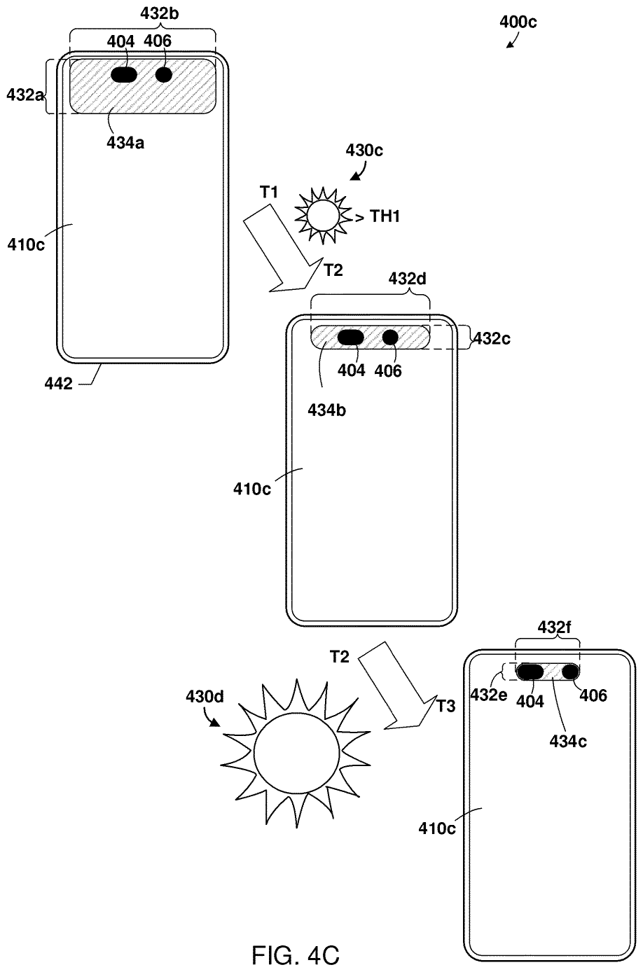

FIG. 4A illustrates a method 400a of controlling a computing device display that includes a display cut out according to various embodiments. With reference to FIGS. 1A-4A, the method 400a may be implemented by a processor (e.g., 210, 212, 214, 216, 218, 252, 260, 306) of a computing device 402, 404 (e.g., 100a-100e, 300), an ambient light sensor (e.g., 328) coupled to the processor, and a display device (e.g., 102, 326) coupled to the processor.

At a first time T1, the processor of the computing device 402 may control a display 410a to present a display mask layer 408a around display cut outs 404, 406. Embodiments, the processor may generate display mask layer 408a without reference to an ambient light intensity. The display mask layer 408a may include a first height 420a and a first width 420b. The processor may monitor whether an ambient light intensity 430a meets an ambient light threshold. For example, the processor may receive an output of an ambient light sensor (e.g., 328) and using information provided in such output may monitor whether the ambient light intensity 430a meets the ambient light threshold.

Based on the information from the ambient light sensor, the processor may determine that the ambient light intensity 430a meets the ambient light threshold. In response to determining that the ambient light intensity 430a meets the ambient light threshold, at a second time T2, the processor of the computing device 402 may control the display 410a to present a display mask region 408b around the display cut outs 404, 406. In some embodiments, in response to determining that the ambient light intensity 430a meets the ambient light threshold, the processor may determine a display mask region 408b. The display mask region 408b may include a second height 420c and a second width 420d. In some embodiments, the second height 420c may be smaller than the first height 420a. In some embodiments, the second width 420d may be smaller than the first width 420b. In some embodiments, the display mask region 408b may substantially match the size, area, and/or shape of the display cut outs 404, 406. In some embodiments, the processor may control the display 410b to modify the display mask layer 408a by the determined display mask region 408b.

In some embodiments, the processor may select a color of the display mask region 408b based on an amount or an intensity of ambient light detected by the processor. In some embodiments, the processor may select a color of the display mask region 408b based on one or more other graphical elements being presented on the display 410a within and/or outside of the display mask region 408b. In embodiments in which the processor selects a color of the display mask region 408b, the processor may control the display 410a to present the selected color in an area of the display mask region 408b that is not directly over one of the display cut outs 404, 406, if any such area is present. For example, the display mask region 408b includes an area between display cut out 404 and display cut out 406 that is not over either of the display cut outs 404, 406. In such embodiments, the processor may control the display 410a to present the selected color within the area of the display mask region 408b that is between display cut out 404 and display cut out 406. In various embodiments.

In some embodiments, the computing device 402 may only include one of the display cut outs 404, 406. In such embodiments, the processor of the computing device 402 may control the display 410a to present the display mask region 408b in a manner that substantially matches the area, size, shape, etc. of the single display cut out 404, 406. In some embodiments, at least one edge of the display mask region 408b may match at least one edge of the display cut outs 404, 406.

FIG. 4B illustrates a method 400b of controlling a computing device display that includes a display cut out according to various embodiments. With reference to FIGS. 1A-4B, the method 400b may be implemented by a processor (e.g., 210, 212, 214, 216, 218, 252, 260, 306) of a computing device 402, 404 (e.g., 100a-100e, 300), an ambient light sensor (e.g., 328) coupled to the processor, and a display device (e.g., 102, 326) coupled to the processor.

At a first time T1, the processor of the computing device 422 may control a display 410b to present a display mask layer 408c around display cut outs 404, 406. In some embodiments, the processor may generate the display mask layer 408c without reference to an ambient light intensity. In some embodiments, the first display mask layer 408c may include a first height 424a and first width 424b. In some embodiments, the first display mask layer 408c may include one or more first graphical elements 426a arranged in first positions within the first display mask layer 408c. The processor may monitor whether an ambient light intensity 430b meets an ambient light threshold (TH) (e.g., using information output by an ambient light sensor, e.g., 328).

Based on information from the ambient light sensor, the processor may determine that the ambient light intensity 430b meets the ambient light threshold. In response to determining that the ambient light intensity 430b meets the ambient light threshold, at a second time T2, the processor of the computing device 422 may control the display 410b to present a display mask region 408d around the display cut outs 404, 406. The display mask region 408d may include a second height 424c and a second width 424d. In some embodiments, the second height 424c may be smaller than the first height 424a. In some embodiments, the second width 424d may be smaller than the first width 424b. In some embodiments, the display mask region 408d may substantially match the size, area, and/or shape of the display cut outs 404, 406.

In some embodiments, the processor may control the display 410b to modify the display mask layer 408c by the determined display mask region 408d. In some embodiments, the processor may control the display 410b to modify a position, size, an arrangement, or another aspect of one or more of the first graphical elements 426a in the display mask region 408d. In some embodiments, the display mask region 408d may include one or more second graphical elements 426b arranged in second positions within the display mask region 408d. In some embodiments, the second graphical elements 420b may be smaller versions of the first graphical elements 426a. In some embodiments, distance(s) between the second graphical elements 426b may be smaller than distance(s) between the first graphical elements 426a, such that the second graphical elements 426b are displayed closer together than the first graphical elements 426a. In some embodiments, distance(s) between the second graphical elements 426b and the display cut outs 404, 406 may be smaller than distance(s) between the first graphical elements 426a and the display cut outs 404, 406. In some embodiments, at least one edge of the display mask region 408d may match at least one edge of the display cut outs 404, 406.

FIG. 4C illustrates a method 400c of controlling a computing device display that includes a display cut out according to various embodiments. With reference to FIGS. 1A-4C, the method 400c may be implemented by a processor (e.g., 210, 212, 214, 216, 218, 252, 260, 306) of a computing device 402, 404 (e.g., 100a-100e, 300), an ambient light sensor (e.g., 328) coupled to the processor, and a display device (e.g., 102, 326) coupled to the processor.

In some embodiments, the computing device may dynamically modify the display mask region in response to changing ambient light intensity. In some embodiments, the computing device may apply two or more ambient light thresholds, and may dynamically modify the display mask region in response to the ambient light intensity meeting a first threshold, a second threshold, etc.

For example, at a first time T1, the processor of the computing device 442 may control the display 410c to present a display mask layer 434a. The display mask layer 434a may be presented around the display cut outs 404, 406. In some embodiments, the processor may generate the display mask layer 434a without reference to an ambient light intensity. The display mask layer 434a may include a first height 432a and a first width 432b.

The processor may monitor whether an ambient light intensity 430c meets a first ambient light threshold (TH1) (e.g., using information output by an ambient light sensor, e.g., 328). The processor may determine that the ambient light intensity 430c meets the first ambient light threshold TH1, at a second time T2, the processor may control the display 410c to present a first display mask region 434b around the display cut outs 404, 406. The first display mask region 434b may include a second height 432c and a second width 432d. In some embodiments, the second height 432c may be smaller than the first height 432a. In some embodiments, the second width 432d may be smaller than the first width 432b.

The processor may monitor whether an ambient light intensity 430d meets a second ambient light threshold (TH2). In this example, the ambient light intensity 430d is greater than the ambient light intensity 430c. The processor may determine that the ambient light intensity 430d meets the second ambient light threshold TH2. In response to determining that the ambient light intensity 430d meets the second ambient light threshold TH2, at a second time T2, the processor may control the display 410c to present a second display mask region 434c around the display cut outs 404, 406. The second display mask region 434c may include a third height 432e and a third width 432f. In some embodiments, the third height 432e may be smaller than the second height 432c. In some embodiments, the third width 432f may be smaller than the second width 432d.

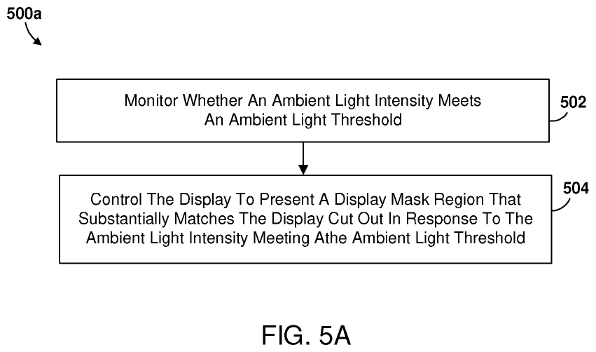

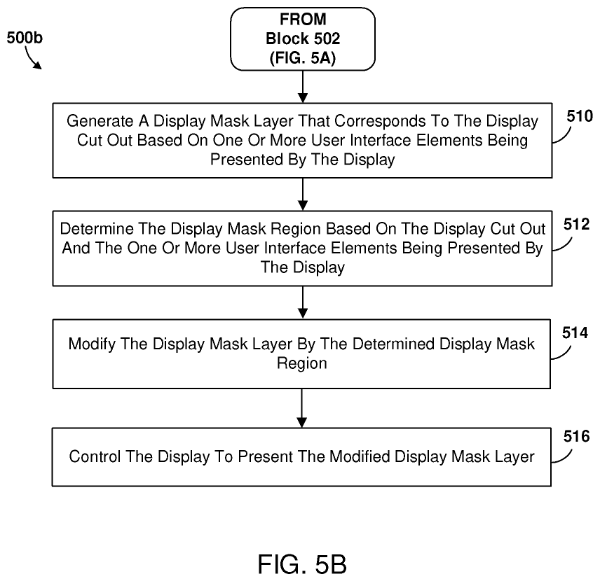

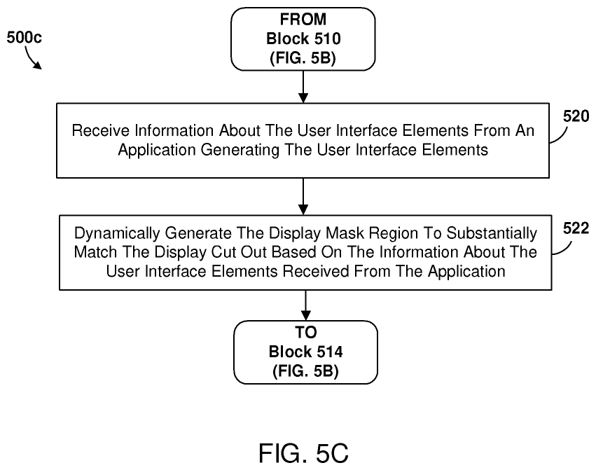

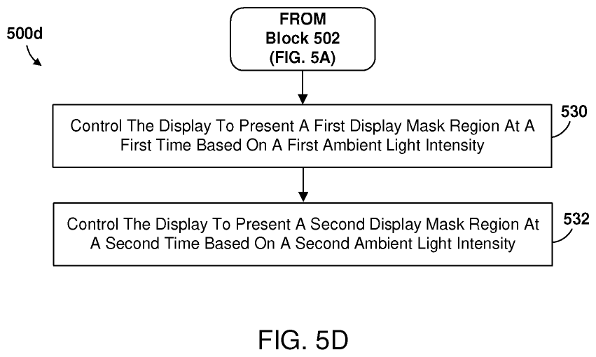

FIG. 5A is a process flow diagram illustrating a method 500a that may be performed by a processor of a computing device for controlling a computing device display that includes a display cut out according to various embodiments. With reference to FIGS. 1A-5A, means for performing the operations of the method 500a may include a processor (e.g., 210, 212, 214, 216, 218, 252, 260, 306) of a computing device 402, 404 (e.g., 100a-100e, 300, 402, 422, 442), an ambient light sensor (e.g., 328) coupled to the processor, and a display device (e.g., 102, 326, 410) coupled to the processor.

In block 502, the processor may monitor whether an ambient light intensity (i.e., the brightness or intensity of ambient light) meets an ambient light threshold. For example, the processor may monitor whether an ambient light intensity 430a, 430b, 430c meets an ambient light threshold, which may be a brightness or intensity value stored in memory.

In block 504, the processor may control the display to present a display mask region that substantially matches the display cut out in response to the ambient light intensity (or intensity of ambient light) meeting the ambient light threshold. For example, the processor may control the display 102, 410a to present display mask region 408a around display cut outs 404 in response to determining that the ambient light intensity 430 meets the ambient light threshold. In some embodiments, the processor may control the display to present the display mask region based on one or more user interface elements being presented by the display. For example, the processor may control the display 410b to present the mask region 408d based on the graphical elements 426b.

FIG. 5B is a process flow diagram illustrating operations 500b that may be performed by a processor of a computing device as part of the method 500a for controlling a computing device display that includes a display cut out according to various embodiments. With reference to FIGS. 1A-5B, means for performing the operations 500b may include a processor (e.g., 210, 212, 214, 216, 218, 252, 260, 306) of a computing device 402, 404 (e.g., 100a-100e, 300, 402, 422, 442), an ambient light sensor (e.g., 328) coupled to the processor, and a display device (e.g., 102, 326, 410) coupled to the processor.

After monitoring whether an ambient light intensity meets an ambient light threshold in block 502 as described, the processor may generate a display mask layer that corresponds to the display cut out based on the one or more user interface elements being presented by the display in block 510.

In block 512, the processor may determine the display mask region based on the display cut out and the one or more user interface elements being presented by the display. For example, the processor may determine the display mask region 408d based on the one or more user interface elements 426a, 426b.

In block 514, the processor may modify the display mask layer by the determined display mask region. For example, the processor may modify the display mask layer 408c by the determined display mask region 408d.

In block 516, the processor may control the display to present the modified display mask layer. For example, the processor may control the display 410b to present the display mask region 408d.

FIG. 5C is a process flow diagram illustrating operations 500c that may be performed by a processor of a computing device as part of the method 500a for controlling a computing device display that includes a display cut out according to various embodiments. With reference to FIGS. 1A-5C, means for performing the operations 500c may include a processor (e.g., 210, 212, 214, 216, 218, 252, 260, 306) of a computing device 402, 404 (e.g., 100a-100e, 300, 402, 422, 442), an ambient light sensor (e.g., 328) coupled to the processor, and a display device (e.g., 102, 326, 410) coupled to the processor.

After generating a display mask layer that corresponds to the display cut out based on the one or more user interface elements being presented by the display in block 510 as described, the processor may receive information about the user interface elements from an application generating the user interface elements in block 520. For example, the processor may receive information from a phone application about the user interface elements 426a and/or 426b.

In block 522, the processor may dynamically generate the display mask region to substantially match the display cut out based on the information about the user interface elements received from the application. For example, the processor may dynamically generate the display mask region 424c using the information about the user interface elements 426a and/or 426b to substantially match the display cut out(s) 404, 406. In some embodiments, at least one edge of the display mask region (e.g., 408d) may match at least one edge of the display cut out (e.g., 404, 406).

The processor may modify the display mask layer by the determined display mask region in block 514 as described.

FIG. 5D is a process flow diagram illustrating operations 500d that may be performed by a processor of a computing device as part of the method 500a for controlling a computing device display that includes a display cut out according to various embodiments. With reference to FIGS. 1A-5D, means for performing the operations 500d may include a processor (e.g., 210, 212, 214, 216, 218, 252, 260, 306) of a computing device 402, 404 (e.g., 100a-100e, 300, 402, 422, 442), an ambient light sensor (e.g., 328) coupled to the processor, and a display device (e.g., 102, 326, 410) coupled to the processor.

After the processor monitors whether an ambient light intensity meets an ambient light threshold in block 502 as described, the processor may control the display to present a first display mask region at a first time based on a first ambient light intensity in block 530. For example, the processor may control the display 410b to present the first display mask region 434b around display cut outs in response to determining that the ambient light intensity 430c meets a first ambient light threshold TH1.

In block 532, the processor may control the display to present a second display mask region at a second time based on a second ambient light intensity. For example, the processor may control the display 410c to present the second display mask region 434c around display cut outs in response to determining that the ambient light intensity 430d meets a second ambient light threshold TH2.

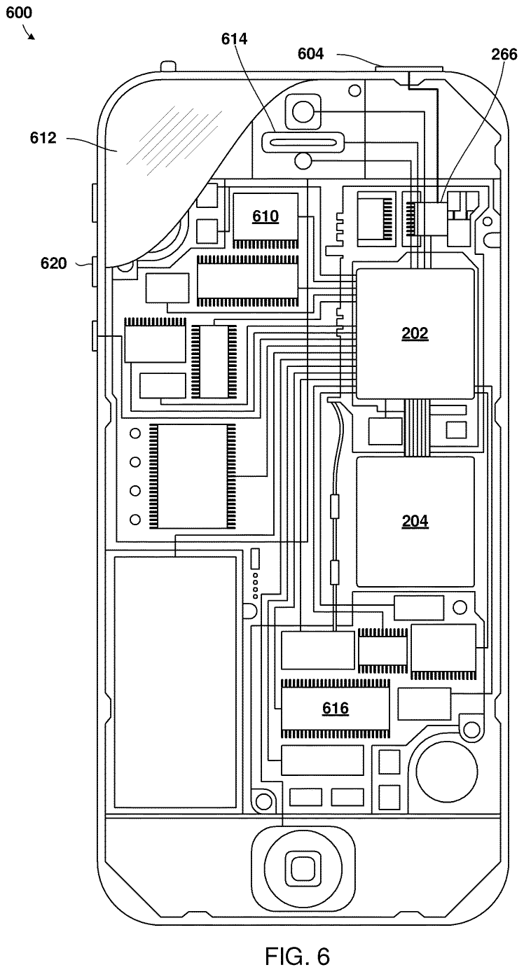

FIG. 6 is a component block diagram of a computing device 600 suitable for use with various embodiments. With reference to FIGS. 1A-6, the computing device 600 (e.g., 100a-100e, 300, 402, 422, and 442) may be configured to perform the operations of the methods and operations 400a-500d in various embodiments.

The computing device 600 may include a first SOC 202 (e.g., a SOC-CPU) coupled to a second SOC 204 (e.g., a 5G capable SOC). The first and second SOCs 202, 204 may be coupled to internal memory 616, a display 612, and to a speaker 614. Additionally, the computing device 600 may include an antenna 604 for sending and receiving electromagnetic radiation that may be connected to a wireless data link and/or cellular telephone transceiver 266 coupled to one or more processors in the first and/or second SOCs 202, 204. The computing device 600 may also include menu selection buttons or rocker switches 620 for receiving user inputs.

The computing device 600 also may include a sound encoding/decoding (CODEC) circuit 610, which digitizes sound received from a microphone into data packets suitable for wireless transmission and decodes received sound data packets to generate analog signals that are provided to the speaker to generate sound. Also, one or more of the processors in the first and second SOCs 202, 204, wireless transceiver 266 and CODEC 610 may include a digital signal processor (DSP) circuit (not shown separately).

The processors of the network computing device 600 and the computing device 600 may be any programmable microprocessor, microcomputer or multiple processor chip or chips that can be configured by software instructions (applications) to perform a variety of functions, including the functions of the various embodiments described below. In some mobile devices, multiple processors may be provided, such as one processor within an SOC 204 dedicated to wireless communication functions and one processor within an SOC 202 dedicated to running other applications. Software applications may be stored in the memory 616 before they are accessed and loaded into the processor. The processors may include internal memory sufficient to store the application software instructions.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a wireless device and the wireless device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA1020TM), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the methods and operations 400a-500d may be substituted for or combined with one or more operations of the methods and operations 400a-500d.

Implementation examples are described in the following paragraphs. While some of the following implementation examples are described in terms of example systems and methods, further example implementations may include: the example operations discussed in the following paragraphs may be implemented by various computing devices for controlling a computing device display that includes a display cutout; the example methods discussed in the following paragraphs implemented by computing device including a processor configured with processor-executable instructions to perform operations of the methods of the following implementation examples; the example methods discussed in the following paragraphs implemented by computing device including means for performing functions of the methods of the following implementation examples; and the example methods discussed in the following paragraphs may be implemented as a non-transitory processor-readable storage medium having stored thereon processor-executable instructions configured to cause a processor of a computing device to perform the operations of the methods of the following implementation examples.

Example 1. A method of controlling a computing device display that includes a display cut out, including: monitoring whether an ambient light intensity meets an ambient light threshold; and controlling the display to present a display mask region that substantially matches the display cut out in response to the ambient light intensity meeting the ambient light threshold.

Example 2. The method of claim 1, in which controlling the display to present a display mask region that substantially matches the display cut out includes controlling the display to present the display mask region based on one or more user interface elements being presented on the display.

Example 3. The method of claim 1, in which controlling the display to present a display mask region that substantially matches the display cut out includes: generating a display mask layer that corresponds to the display cut out based on one or more user interface elements being presented by the display; determining the display mask region based on the display cut out and the one or more user interface elements being presented by the display; modifying the display mask layer by the determined display mask region; and controlling the display to present the modified display mask layer.

Example 4. The method of claim 3, in which determining the display mask region based on the display cut out and the one or more user interface elements being presented by the display includes: receiving information about the user interface elements from an application generating the user interface elements; and dynamically generating the display mask region to substantially match the display cut out based on the information about the user interface elements received from the application.

Example 5. The method of any of claims 1-4, in which: controlling the display to present a display mask region that substantially matches the display cut out in response to ambient light intensity meeting a ambient light threshold includes controlling the display to present a first display mask region at a first time based on a first ambient light intensity and controlling the display to present a second display mask region at a second time based on a second ambient light intensity.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

1. A computing device, comprising:
a display that includes a display cut out;
an ambient light sensor; and
a processor coupled to the display and the ambient light sensor, wherein the processor is configured to:
monitor whether an intensity of ambient light meets an ambient light threshold; and
control the display to present a display mask region that substantially matches the display cut out in response to the intensity of ambient light meeting the ambient light threshold.

2. The computing device of claim 1, wherein the processor is further configured to control the display to present the display mask region based on one or more user interface elements being presented on the display.

3. The computing device of claim 1, wherein the processor is further configured to:
generate a display mask layer that corresponds to the display cut out based on one or more user interface elements being presented on the display;
determine the display mask region based on the display cut out and the one or more user interface elements being presented by the display;
modify the display mask layer by the determined display mask region; and
control the display to present the modified display mask layer.

4. The computing device of claim 1, wherein the processor is further configured to:
generate a display mask layer that corresponds to the display cut out based on one or more user interface elements being presented on the display;
receive information about the user interface elements from an application generating the user interface elements;
dynamically generate the display mask region to substantially match the display cut out based on the information about the user interface elements received from the application;
modify the display mask layer by the determined display mask region; and
control the display to present the modified display mask layer.

5. The computing device of claim 1, wherein the processor is further configured to control the display to present a first display mask region at a first time based on a first intensity of ambient light and control the display to present a second display mask region at a second time based on a second intensity of ambient light.

6. A method of controlling a computing device display that includes a display cut out, comprising:
monitoring whether an ambient light intensity meets an ambient light threshold; and
controlling the display to present a display mask region that substantially matches the display cut out in response to the ambient light intensity meeting the ambient light threshold.

7. The method of claim 6, wherein controlling the display to present a display mask region that substantially matches the display cut out comprises controlling the display to present the display mask region based on one or more user interface elements being presented on the display.

8. The method of claim 6, wherein controlling the display to present a display mask region that substantially matches the display cut out comprises:
generating a display mask layer that corresponds to the display cut out based on one or more user interface elements being presented on the display;
determining the display mask region based on the display cut out and the one or more user interface elements being presented on the display;
modifying the display mask layer by the determined display mask region; and
controlling the display to present the modified display mask layer.

9. The method of claim 8, wherein determining the display mask region based on the display cut out and the one or more user interface elements being presented by the display comprises:
receiving information about the user interface elements from an application generating the user interface elements; and
dynamically generating the display mask region to substantially match the display cut out based on the information about the user interface elements received from the application.

10. The method of claim 6, wherein controlling the display to present a display mask region that substantially matches the display cut out in response to ambient light intensity meeting a ambient light threshold comprises controlling the display to present a first display mask region at a first time based on a first ambient light intensity and controlling the display to present a second display mask region at a second time based on a second ambient light intensity.

11. A computing device, comprising:
a display that includes a display cut out;
means for monitoring whether an ambient light intensity meets an ambient light threshold; and
means for controlling the display to present a display mask region that substantially matches the display cut out in response to the ambient light intensity meeting the ambient light threshold.

12. The computing device of claim 11, wherein means for controlling the display to present a display mask region that substantially matches the display cut out comprises means for controlling the display to present the display mask region based on one or more user interface elements being presented on the display.

13. The computing device of claim 11, wherein means for controlling the display to present a display mask region that substantially matches the display cut out comprises:
means for generating a display mask layer that corresponds to the display cut out based on one or more user interface elements being presented by the display;
means for determining the display mask region based on the display cut out and the one or more user interface elements being presented on the display;
means for modifying the display mask layer by the determined display mask region; and
means for controlling the display to present the modified display mask layer.

14. The computing device of claim 13, wherein means for determining the display mask region based on the display cut out and the one or more user interface elements being presented by the display comprises:
means for receiving information about the user interface elements from an application generating the user interface elements; and
means for dynamically generating the display mask region to substantially match the display cut out based on the information about the user interface elements received from the application.

15. The computing device of claim 11, wherein means for controlling the display to present a display mask region that substantially matches the display cut out in response to ambient light intensity meeting a ambient light threshold comprises means for controlling the display to present a first display mask region at a first time based on a first ambient light intensity and controlling the display to present a second display mask region at a second time based on a second ambient light intensity.

16. (canceled)

17. (canceled)

18. (canceled)

19. (canceled)

20. (canceled)
